(19) United States
(12) Patent Application Publication
(10) Pub. No.: US 2009/0245059 A1
(43) Pub. Date: Oct. 1, 2009

(54) METHOD AND APPARATUS FOR RECORDING OR RETRIEVING INFORMATION ON OPTICAL DISC, AND MANUFACTURING PROCESS OF OPTICAL DISC ON WHICH INFORMATION IS RECORDED

(75) Inventor: Toshiyuki KITAHARA, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/414,297

(22) Filed: Mar. 30, 2009

(30) Foreign Application Priority Data
Mar. 31, 2008 (JP) 2008-091871

(51) Int. Cl. G11B 7/0045

(52) U.S. Cl. 369/59.11; G9B/7.01

(57) ABSTRACT

A method for recording information on an optical disc having a recording layer which contains a two-photon absorption compound is provided. In this method, the information to be recorded is obtained as first pit array data indicative of a first linear array of pits, wherein the pits in the first linear array correspond to those to be formed on a plurality of tracks arranged spirally or concentrically on the optical disc. The first pit array data is then converted into second pit array data indicative of a second linear array of the pits. The second linear array of the pits corresponds to that to be obtained as a result of scanning, sequentially in radial directions of the optical disc, the pits arranged in the first linear array along the plurality of tracks on the optical disc. An area of the optical disc, which includes an area corresponding to the plurality of tracks, is scanned with a pulsed laser sequentially in the radial directions of the optical disc while rotating the optical disc. Emission of a pulsed laser beam produced by the pulsed laser is interrupted and resumed according to the second pit array data.

### CROSS-REFERENCE TO RELATED APPLICATION(S)

This application claims the foreign priority benefit under Title 35, United States Code, §119(a)-(d), of Japanese Patent Application No. 2008-091871, filed on Mar. 31, 2008 in the Japan Patent Office, the disclosure of which is herein incorporated by reference in its entirety.

### BACKGROUND OF THE INVENTION

1. Field of the Invention

Methods and apparatuses consistent with the present invention relate to recording and retrieval of information on an optical disc having a recording layer which contains a two-photon absorption compound, and to a manufacturing process of such an optical disc on which data is recorded.

2. Description of Related Art

Optical discs, such as CD-R, DVD-ROM, are storage media on which data is retrievably recorded. The speed at which data is recorded on and retrieved from an optical disc (hereinafter referred to as “transfer rate”) shows a yearly increase. The transfer rate for an optical disc is determined by a linear recording density and a rotation speed of the optical disc (see JP 2007-102884 A; also published under US 2007/0079312 A1). The linear recording density is a measure of how tightly bits are packed in a given length of track; i.e., it depends upon how small each recording spot is made. The size of the recording spot, in general, depends upon the wavelength of a laser beam and the NA (numerical aperture) of an objective lens used for recording and retrieval of data. However, it is also known that for a recording medium having a recording layer which contains a two-photon absorption compound, for example, the size is reduced by a factor of the square root of 2. As for the existing optical discs made of any practicable material currently available, the rotation speeds of the optical discs are limited to 10,000 rpm or so at the maximum in view of their strength.

As the attempts to increase the recording density and the rotation speed are both approaching their limits, a novel scheme for increasing the transfer rate is now desired.

In a process of manufacturing optical discs of a so-called ROM type on which data is recorded, a stamper may be employed by which a prefabricated pit pattern is transferred to blank discs in cases where the number of discs to be manufactured is sufficiently large. On the other hand, there are cases where small batches of discs are to be manufactured, in which cases the recording process should be repeated for each blank medium of a write-once or so-called WORM type such as CD-R on a one-by-one basis. This manufacturing process however takes much time, and it would thus be desirable to further increase the recording speed.

The present invention has been made against this backdrop.

### SUMMARY OF THE INVENTION

It is one aspect of the present invention to provide a method for recording or retrieving information on an optical disc and an apparatus for recording information on an optical disc in which the data transfer rate is increased, as well as to provide a method for recording or retrieving data on an optical disc, a method for manufacturing an optical disc on which information is recorded and an apparatus for recording information on an optical disc in which the recording speed is increased.

More specifically, in a first method aspect of the present invention, there is provided a method for recording information on an optical disc having a recording layer containing a two-photon absorption compound. The method comprises the steps of: obtaining the information to be recorded, as first pit array data indicative of a first linear array of pits, wherein the pits in the first linear array correspond to those to be formed on a plurality of tracks arranged spirally or concentrically on the optical disc; converting the first pit array data into second pit array data indicative of a second linear array of the pits, wherein the second linear array of the pits correspond to that to be obtained as a result of scanning, sequentially in radial directions of the optical disc, the pits arranged in the first linear array along the plurality of tracks on the optical disc; and scanning an area of the optical disc, which includes an area corresponding to the plurality of tracks, with a pulsed laser sequentially in the radial directions of the optical disc while rotating the optical disc, wherein emission of a pulsed laser beam produced by the pulsed laser is interrupted and resumed according to the second pit array data.

According to the method as described above, the pulsed laser beam sweeps over the area of the optical disc corresponding to the plurality of tracks, sequentially in the radial directions of the optical disc. Meanwhile, the emission of the pulsed laser beam is interrupted and resumed according to the second pit array data. By interrupting and resuming the emission of the pulsed laser beam, binary data expressed in a series of dots arranged in the order of the second pit array is formed, where one pulse of the pulsed laser beam makes one unit dot and one pit consists of at least one dot, that is, one dot forms one pit or part of a pit. The dot which forms one pit or part of a pit will hereinafter be referred to as “pit-constituting dot.” Since the second pit array data is obtained as an array of data resulting from the scanning, performed sequentially in radial directions of the optical disc, of the pits arranged in the first linear array along the plurality of tracks arranged spirally or concentrically on the optical disc, the resulting pits recorded on the optical disc are arranged in the order of the first pit array as viewed sequentially along the tracks arranged spirally or concentrically on the optical disc.

Consequently, according to the first method aspect of the present invention as described above, pits are recorded on the plurality of tracks during one cycle of rotation of the optical disc, and thus high-speed recording can be achieved without increasing the rotation speed of the optical disc. In other words, the transfer rate higher than that of the existing method can be achieved if the rotation speed is the same.

In addition, the above-described method is configured to perform recording not by changing the index of refraction of the heat mode recording material but by directing a pulsed laser beam to a recording layer containing a two-photon absorption compound, and thus the recording spots (pits) can be formed in a very short time.

The above method may further comprise the steps of: emitting a laser beam to the optical disc while rotating the optical disc so that the laser beam sequentially traces the tracks along which the pits are formed; receiving the laser beam transmitted by or reflected from the optical disc; and demodulating the information from an intensity signal of the received laser beam, whereby information recorded on an optical disc is retrieved. That is, the information recorded on the optical disc can be verified in these additional steps.

In this way, in contrast to the information recording process in which the pulsed laser beam for forming pits is applied sequentially with the pulsed laser scanning the optical disc in the radial directions thereof, the laser beam applied in the information retrieving process may be regulated to sequentially trace the plurality of tracks arranged spirally or concentrically on the optical disc, so that information can be retrieved in the same manner as is the case with the prevailing CDs or DVDs on which information is recorded in the conventional sequence. As a result, the optical disc on which information is recorded in accordance with the above-described method can be driven in any existing optical disc drive so as to retrieve the information therefrom.

In a second method aspect of the present invention, a method for recording information on an optical disc having a recording layer containing a two-photon absorption compound comprises the steps of: obtaining the information to be recorded, as pit array data indicative of a linear array of pits, wherein the pits in the linear array correspond to those to be formed on the optical disc; and scanning the optical disc sequentially in radial directions of the optical disc with a pulsed laser while rotating the optical disc, wherein emission of a pulsed laser beam produced by the pulsed laser is interrupted and resumed according to the pit array data.

According to this method, pits arranged in a radial direction of the optical disc are formed on each track (herein, tracks are arranged in radial directions) by the process of scanning the optical disc in the radial direction thereof with the pulsed laser producing a pulsed laser beam interrupted and resumed according to the pit array data. Since pits are arranged in the radial direction to thereby record a large amount of information on one track, the information can be rapidly recorded without the need to further increase the rotation of the optical disc. In other words, the transfer rate higher than that of the existing method can be achieved if the rotation speed is the same.

In another aspect, there is provided a method for retrieving information recorded on an optical disc having a recording layer containing a two-photon absorption compound, which comprises the steps of: receiving the optical disc on which information is recorded by the method described above; emitting a laser beam and scanning an area of the optical disc in which the pits are formed, sequentially in the radial directions of the optical disc with the laser beam while rotating the optical disc; receiving the laser beam transmitted by or reflected from the optical disc; and demodulating the information from an intensity signal of the received laser beam.

According to this method, the information retrieval process, like the recording process as in the method described above, includes the step of scanning the relevant area of the optical disc in radial directions of the optical disc with the laser beam so that the signal is read out from the pit pattern formed on the optical disc. To be more specific, when information is retrieved from the optical disc, a signal is read out from the pits arranged on each track in the radial direction of the optical disc; therefore, the information can be retrieved more rapidly than can be by the existing method even if the rotation speed is the same.

In yet another aspect of the present invention, there is provided a method for manufacturing an optical disc on which information is recorded. This method comprises the steps of: providing an optical disc having a recording layer containing a two-photon absorption compound; obtaining the information to be recorded, as first pit array data indicative of a first linear array of pits, wherein the pits in the first linear array correspond to those to be formed on a plurality of tracks arranged spirally or concentrically on the optical disc; converting the first pit array data into second pit array data indicative of a second linear array of the pits, wherein the second linear array of the pits correspond to that to be obtained as a result of scanning, sequentially in radial directions of the optical disc, the pits arranged in the first linear array along the plurality of tracks on the optical disc; and scanning an area of the optical disc, which includes an area corresponding to the plurality of tracks, with a pulsed laser sequentially in the radial directions of the optical disc while rotating the optical disc, wherein emission of a pulsed laser beam produced by the pulsed laser is interrupted and resumed according to the second pit array data.

According to this method, as in the first method aspect of the present invention, the pulsed laser beam sweeps over the area of the optical disc corresponding to the plurality of tracks, sequentially in the radial directions of the optical disc, so that the pits are formed on the optical disc.

In this method, pits are recorded on the plurality of tracks during one cycle of rotation of the optical disc, and thus high-speed recording can be achieved without increasing the rotation speed of the optical disc. That is, an optical disc on which information is recorded on a plurality of tracks arranged spirally or concentrically such as CDs or DVDs can be manufactured at high speeds.

In a first apparatus aspect of the present invention, which corresponds to the first method aspect of the present invention, an apparatus for recording information on an optical disc having a recording layer containing a two-photon absorption compound is provided. This apparatus comprises: a pulsed laser configured to produce a pulsed laser beam; a shutter configured to interrupt and resume emission of the pulsed laser beam produced by the pulsed laser; a deflector configured to deflect the pulsed laser beam produced by the pulsed laser, in radial directions of the optical disc; a motor configured to rotate the optical disc; and a controller configured to control the pulsed laser, the shutter, the deflector and the motor. The motor comprises: a modulator configured to modulate information to be recorded into first pit array data indicative of a first linear array of pits, wherein the pits in the first linear array correspond to those to be formed on a plurality of tracks arranged spirally or concentrically on the optical disc; a data converter configured to convert the first pit array data into second pit array data indicative of a second linear array of the pits, wherein the second linear array of the pits correspond to that to be obtained as a result of scanning, sequentially in radial directions of the optical disc, the pits arranged in the first linear array along the plurality of tracks on the optical disc; a pulsed laser driver configured to cause the pulsed laser to produce the pulsed laser beam; a motor driver configured to cause the motor to rotate the optical disc; a deflector driver configured to regulate the deflector so as to scan an area of the optical disc, which includes an area corresponding to the plurality of tracks, with the pulsed laser sequentially in the radial directions of the optical disc; and a shutter driver configured to cause the shutter to selectively interrupt or resume emission of the pulsed laser beam according to the second pit array data.

With this apparatus, the relevant area of the optical disc is scanned with the pulsed laser by the deflector under the control of the deflector driver while emission of the pulsed laser beam from the pulsed laser is interrupted or resumed by the shutter according to the second pit array data under the control of the shutter driver. Since the second pit array data is obtained as an array of data resulting from the scanning, performed sequentially in radial directions of the optical disc, of the pits arranged in the first linear array along the plurality of tracks arranged spirally or concentrically on the optical disc, the resulting pits recorded on the optical disc are arranged in the order of the first pit array as viewed sequentially along the tracks arranged spirally or concentrically on the optical disc.

Consequently, according to the first apparatus aspect of the present invention as described above, pits are recorded on the plurality of tracks during one cycle of rotation of the optical disc, and thus high-speed recording can be achieved without increasing the rotation speed of the optical disc. In other words, the transfer rate higher than that of the existing apparatus can be achieved if the rotation speed is the same.

In a second apparatus aspect of the present invention, which corresponds to the second method aspect of the present invention, an apparatus for recording information on an optical disc having a recording layer containing a two-photon absorption compound is provided. This apparatus comprises: a pulsed laser configured to produce a pulsed laser beam; a shutter configured to interrupt and resume emission of the pulsed laser beam produced by the pulsed laser; a deflector configured to deflect the pulsed laser beam produced by the pulsed laser, in radial directions of the optical disc; a motor configured to rotate the optical disc; and a controller configured to control the pulsed laser, the shutter, the deflector and the motor, the motor comprises: a modulator configured to modulate information to be recorded into first pit array data indicative of a first linear array of pits, wherein the pits in the first linear array correspond to those to be formed on a plurality of tracks arranged spirally or concentrically on the optical disc; a pulsed laser driver configured to cause the pulsed laser to produce the pulsed laser beam; a motor driver configured to cause the motor to rotate the optical disc; a deflector driver configured to regulate the deflector so as to scan an area of the optical disc, which includes an area corresponding to the plurality of tracks, with the pulsed laser sequentially in radial directions of the optical disc; and a shutter driver configured to cause the shutter to selectively interrupt or resume emission of the pulsed laser beam according to the second pit array data.

With this apparatus, the relevant area of the optical disc is scanned with the pulsed laser by the deflector under the control of the deflector driver while emission of the pulsed laser beam from the pulsed laser is interrupted or resumed by the shutter according to the pit array data under the control of the shutter driver. Therefore, according to this apparatus, pits arranged in a radial direction of the optical disc are formed on each track arranged in a radial direction. Since the pits are arranged in the radial direction to thereby record a large amount of information on one track, the information can be rapidly recorded without the need to further increase the rotation of the optical disc. In other words, the transfer rate higher than that of the existing apparatus can be achieved if the rotation speed is the same.

According to some aspects of the present invention, embodied in the recording methods, manufacturing process and recording apparatuses for an optical disc, as will be described below, scanning in radial directions of an optical disc is performed for the pits to be recorded on an area corresponding to a plurality of tracks which would be formed concentrically or coaxially in the existing methods or apparatuses during one cycle of rotation of an optical disc, and thus high-speed recording can be achieved. According to another aspect of the present invention as embodied in the methods for retrieving information recorded on an optical disc, as will be described below, information recorded on an optical disc by the recording methods adopted according to the present invention can be retrieved.

### BRIEF DESCRIPTION OF THE DRAWINGS

The above aspects and advantages, other advantages and further features of the present invention will become more apparent by describing in detail illustrative, non-limiting embodiments thereof with reference to the accompanying drawings, in which:

FIG. 1 is a schematic diagram showing an optical disc drive according to a first embodiment of the present invention;

FIG. 2 is an enlarged sectional view of an optical pickup and an optical disc;

FIG. 3 is a block diagram of a controller of the optical disc drive according to the first embodiment;

FIG. 4A is a diagram for explaining an array of pits formed on an optical disc;

FIG. 4B is a diagram for explaining data conversion;

FIG. 5A is a diagram for explaining a recording operation of the optical disc drive according to the first embodiment;

FIG. 5B is a diagram for explaining an operation of the optical disc drive retrieving information recorded on an optical disc according to the first embodiment;

FIG. 6 is a block diagram of a controller of an optical disc drive according to a second embodiment of the present invention;

FIG. 7 is a diagram for explaining operations of the optical disc drive recording and retrieving information on an optical disc according to the second embodiment.

### DETAILED DESCRIPTION OF THE EXEMPLARY EMBODIMENTS

A detailed description will be given of the exemplary embodiments of the present invention with reference to the drawings. In the following description, an optical disc drive for recording or retrieving data on an optical disc is taken as an example of an apparatus for recording or retrieving information on an optical disc according to one exemplary embodiment of the present invention.

### First Embodiment

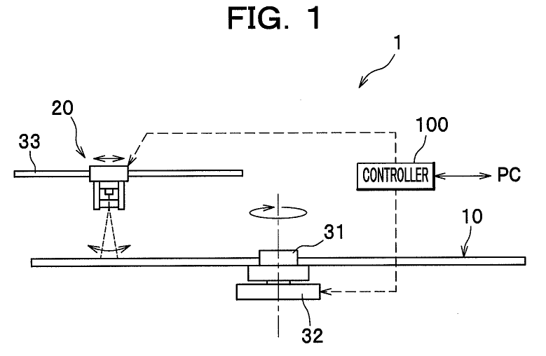

As shown in FIG. 1, an optical disc drive 1 is an apparatus for optically recording information (data) received from a computer PC or the like on an optical disc 10, and principally includes a spindle 31 configured to support an optical disc 10, a motor 32 configured to rotate the spindle 31, an optical pickup 20, a guide 33 configured to guide the movement of the optical pickup 20 in a radial direction of the optical disc 10, and a controller 100.

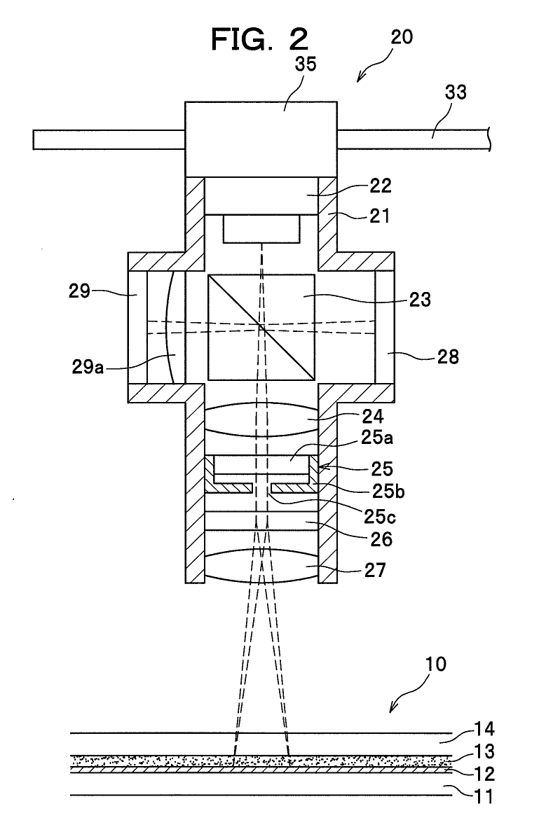

As shown in FIG. 2, the optical disc 10 is of a laminated structure with, by way of example, a substrate 11 and some layers which includes a reflecting layer 12, a recording layer 13 and a cover layer laminated on top of the substrate 11 in this order.

The substrate 11 is a board supporting the recording layer 13, and made of a plastic plate or the like.

The reflecting layer 12 is a layer which reflects a laser beam into the optical pickup 20 when recorded data is retrieved. The reflecting layer 12 is optional, and may thus be omitted if the optical pickup 20 is configured such that a laser beam emitted from a laser light source and transmitted by the optical disc 10 is received at a side opposite to the laser light source of the optical pickup 20.

The recording layer 13 is a layer which contains a two-photon absorption compound. The two-photon absorption compound is a compound which absorbs light by excitation of electrons only if two photons enter the compound simultaneously (to be more exact, within an extremely short period of time). In cases where the two-photon absorption compound is used for an optical information recording medium, excitation energy of the electrons is utilized to induce a chemical reaction which modulates the refraction index, absorptivity and the like of light (light for retrieval or decoding of information). The two-photon absorption compound usable for implementing the present invention may include diarylethenes, for example.

The cover layer 14 is a layer which protects the recording layer 13, and is made of any material which can transmit a laser beam emitted in the recording and retrieving operations. For example, the cover layer 14 may be made of a resin or glass.

The optical disc 10 may be provided with one or more of other layers such as an antireflection coating.

On the other hand, the optical pickup 20 includes a barrel 21, and optical components housed in the barrel 21 which include a laser 22, as a laser light source, a beam splitter 23, a collimating lens 24, a shutter 25, a deflector 26, an objective lens 27, a first photosensor 28, and a second photosensor 29.

The laser 22 is a pulsed laser which intermittently emits a laser beam, and may preferably but not necessarily be a femtosecond laser light source for emitting a strong laser beam for an extremely short period of time in order to effectively induce a two-photon absorption reaction. It is to be understood that a laser medium for use in this laser 22 is not limited to any particular medium as long as the medium can induce a two-photon absorption reaction in the recording layer 13.

The beam splitter 23 is composed of a semitransparent mirror, and located downstream of the laser 22 along a path to be traveled by a pulsed laser beam emitted from the laser 22. The beam splitter 23 splits the pulsed laser beam emitted from the laser 22 into two beams one of which is reflected therein to branch off toward the first photosensor 28, and splits a beam coming back from the optical disc 10 into two beams one of which is reflected therein to branch off toward the second photosensor 29.

The collimating lens 24 is a lens located downstream of the beam splitter 23 along the path to be travelled by a pulsed laser beam emitted from the laser 22. The collimating lens 24 makes the pulsed laser beam into a parallel beam.

The shutter 25 is an element configured to interrupt and resume emission of the pulsed laser beam, and includes a deflection element 25a and a shutter plate 25b having an aperture 25c. The shutter 25 is located downstream of the collimating lens 24 along the path to be travelled by a pulsed laser beam emitted from the laser 22. The shutter 25 may preferably but not necessarily be a non-mechanical optical switch for the purpose of high-speed operation. The deflection element 25a is composed of an electrooptical modulator (EOM) including an electrooptic material in which the indices of refraction are changed by an input signal. When the deflection element 25a receives a signal, the pulsed laser beam is allowed to pass through the aperture 25c. When the deflection element 25a does not receive a signal, the pulsed laser beam is interrupted by the shutter plate 25b.

The deflector 26 is composed of an electrooptical modulator (EOM), and located downstream of the shutter 25 along the path to be travelled by a pulsed laser beam emitted from the laser 22. The deflector 26 is a device configured to deflect the pulsed laser beam in the radial direction of the optical disc 10 in accordance with an input signal.

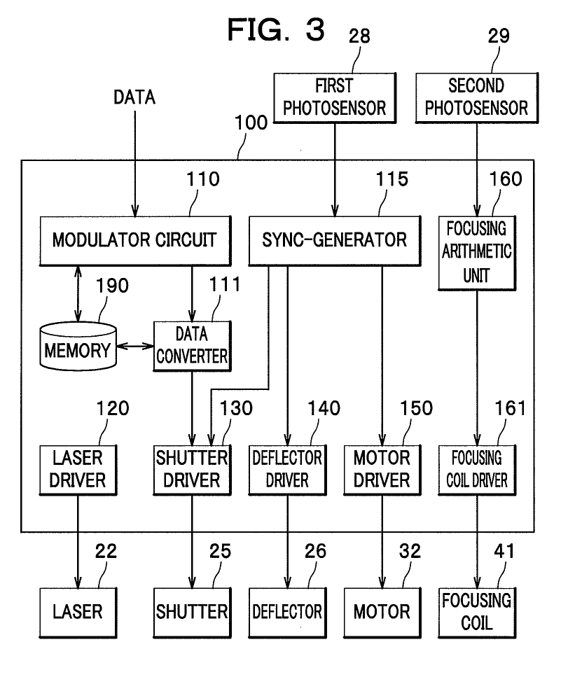

The objective lens 27 is located downstream of the deflector 26 along the path to be travelled by a pulsed laser beam emitted from the laser 22. The objective lens 27 serves to converge the pulsed laser beam so as to make the pulsed laser beam focused in the recording layer 13. The position of the objective lens 27 is moved by a focusing coil 41 (not shown; see FIG. 3), thereby adjusting the focus of the objective lens 27 to properly focus the pulsed laser beam.

The first photosensor 28 is a transducer which receives a pulsed laser beam branched off in the beam splitter 23 and converts the received pulsed laser beam into a signal to be sent to the controller 100.

The optical pickup 20 as described above is configured to move along a guide 33, i.e., in the radial direction of the optical disc, by an actuator 35 known in the art.

As shown in FIG. 3, the controller 100 receives data to be recorded, and controls the laser 22, shutter 25, deflector 26, motor 32 and focusing coil 41, based upon the signals received from the first photosensor 28 and the second photosensor 29. The controller 100 includes a modulator circuit 110, a data converter 111, a sync-generator 115, a laser driver 120, a shutter driver 130, a deflector driver 140, a motor driver 150, a focusing arithmetic unit 160, a focusing coil driver 161, and a memory 190. Each unit of the controller 100 is composed of a dedicated circuit, or implemented by execution of a program on a computer which includes a CPU, a ROM, a RAM and other components.

The modulator circuit 110, which is one example of a modulator, is a circuit which modulates data to be recorded into digital data (first pit array data) indicative of a linear array of pits. The modulator circuit 110 may be composed of an EFM (eight-to-fourteen modulation) modulator circuit known in the art.

The data converter 111 is a device which converts the first pit array data obtained as a result of modulation in the modulator circuit 110 into second pit array data indicative of a second linear array of the pits, wherein the second linear array of the pits correspond to that to be obtained as a result of scanning, sequentially in radial directions of the optical disc 10, the pits arranged in the first linear array along the plurality of tracks on the optical disc 10.

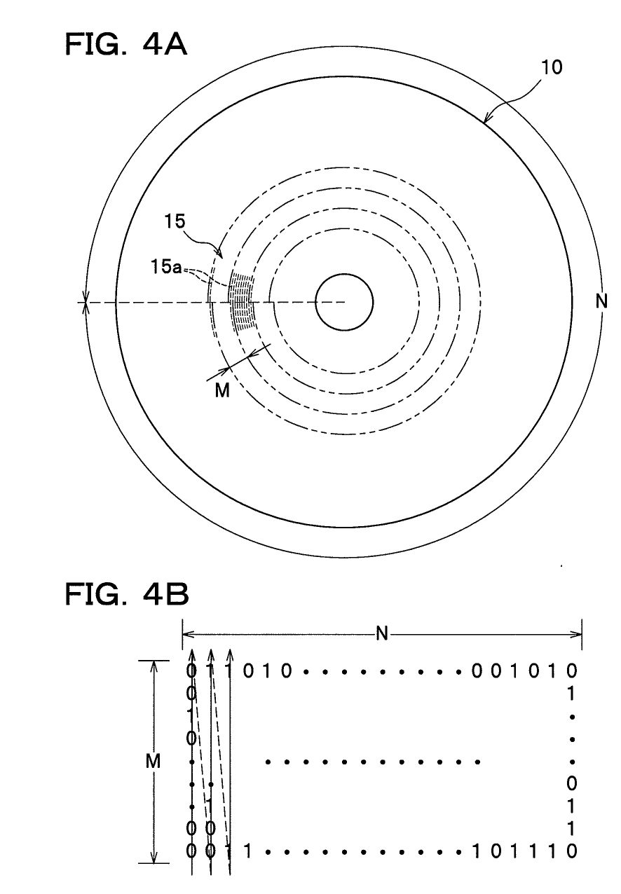

One example of such conversion is shown in FIGS. 4A and 4B. As shown in FIG. 4A, the optical disc 10 hypothetically has a set of tracks (or track set) 15 which includes a plurality of tracks 15a spirally arranged thereon. It is understood that the spirally arranged tracks 15a are tracks continuously connected together in series such that one track is connected to another track adjacent thereto which is connected to yet another track adjacent thereto, and thus may be considered to be a single track. However, in the present description, a plurality of turns of one continuous track are counted and referred to as a plurality of tracks 15a for the sake of convenience. In the present embodiment, the optical disc drive 1 is configured to form (record) all the pits on the tracks 15a included in the track set 15 while the optical disc 10 makes one turn, as will be described later. One track set 15 includes M tracks 15a, each of which contain N pieces of digital data arranged circumferentially in one turn. The number M of tracks 15a included in the track set 15 may be set, for example, in the range of two to several thousands. It is to be noted that the track set 15 is represented in an exaggerated proportion in FIG. 4A for illustration purposes.

As shown in FIG. 4B, the digital data can be represented in a matrix of N columns and M rows. The order of arrangement (linear array) of pits followed by the optical disc drive 1 when information recorded on the optical disc is retrieved corresponds to a linear array consisting of pieces of digital data arranged laterally (i.e., in the circumferential direction of the optical disc 10) connected in series, one row to an adjacent row, as shown in FIG. 4B. The data converter 111 creates second pit array data by rearranging the pieces of digital data (first pit array data) into the order scanned sequentially in the vertical direction as indicated by an arrow in FIG. 4B. In other words, one exemplary method of creating the second pit array data is to pick up the first pit array data every N-th pieces of data for rearrangement. Supposing, for example, the data consist of 1st to 20th pieces and N is 3, the pieces of data are picked up every 3 pieces, i.e., the 4th, 7th, 10th, 13th, 16th and 19th pieces of data are picked up and arranged, and then the 2nd, 5th, 8th, 11th, 14th, 17th, 20th, 3rd, 6th, 9th, 12th, 15th and 18th pieces of data are picked up and arranged in this order. The method consistent with the present invention for converting the first pit array data into the second pit array data is not limited to this example.

It is to be understood that “1” and “0” in FIG. 4B may be considered to correspond to an area to be exposed and an area not to be exposed, respectively, on the optical disc 10, during the recording operation. The second pit array data created by the data converter 111 is outputted to the shutter driver 130.

The sync-generator 115 is a circuit configured to receive an intensity signal of light detected by the first photosensor 28 and to generate a synchronizing signal with the same timing (i.e., at the same frequency) as that of the received intensity signal. This signal is used to synchronize the operations of the shutter driver 130, the deflector driver 140 and the motor driver 150. It is to be understood that the synchronizing signal generated in the sync-generator 115 may not necessarily be based upon the signal received from the first photosensor 28.

The laser driver 120 is a known element which generates a driving signal for causing the laser 22 to emit a laser beam, and sends the same to the laser 22.

The shutter driver 130 is a device which drives the shutter 25 in accordance with the second pit array data received from the data converter 111. To be more specific, the shutter driver 130 receives signals inputted in the order of the linear array of signals “1” and “0” as indicated by an arrow in FIG. 4B, and causes the shutter 25 to transmit a pulsed laser beam from the laser 22 when the shutter driver 130 receives a signal “1”, and causes the shutter 25 to interrupt the pulsed laser beam from the laser 22 when the shutter driver 130 receives a signal “0”. In other words, the shutter driver 130 is configured to cause the shutter 25 to selectively interrupt or resume emission of the pulsed laser beam according to the second pit array data. The shutter driver 130 operates at times determined by a synchronizing signal from the sync-generator 115.

The deflector driver 140 is a device which drives the deflector 26 so as to scan an area of a rotating optical disc 10, which includes an area corresponding to the track set 15, with a pulsed laser beam sequentially in the radial directions of the optical disc 10. To be more specific, the deflector driver 140 is configured to output a constant signal with a predetermined frequency to the deflector 26, to thereby deflect a pulsed laser beam received from the laser 22 while keeping the pulsed laser beam sized in a predetermined beam diameter. The deflector driver 140 receives a synchronizing signal from the sync-generator 115, and the phase of signals with the predetermined frequency outputted from the deflector driver 140 is adjusted in accordance with the synchronizing signal.

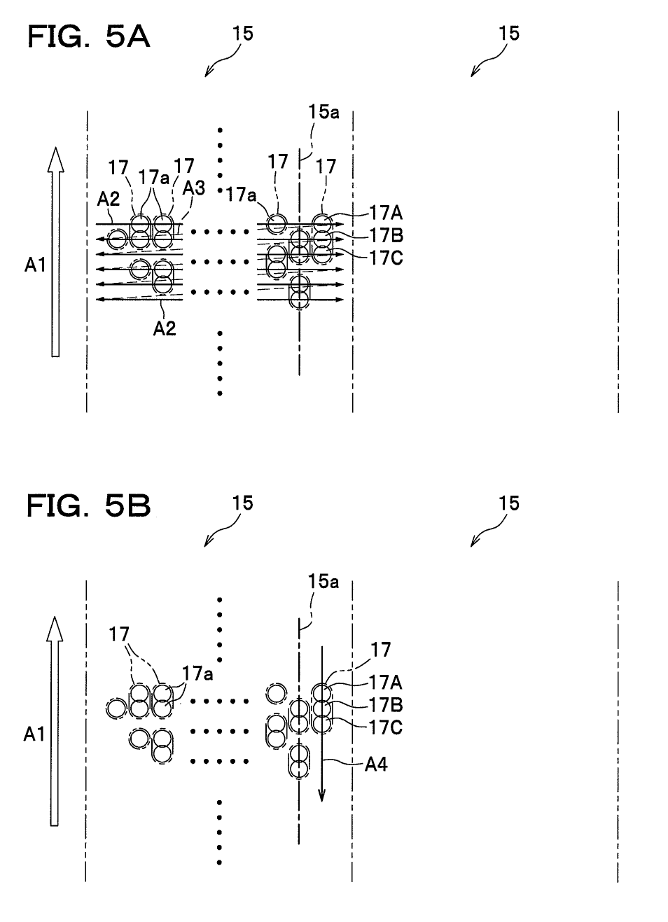

The speed of scanning the optical disc 10 with a pulsed laser beam sequentially in the radial directions is regulated by the deflector driver 140 such that the laser pulses sequentially directed to the optical disc 10 will not overlap on the optical disc 10 and preferably the radially adjacent pit-constituting dots 17a (see FIG. 5A) will be formed at intervals equivalent to the track pitch. It is however understood that the scanning in the radial directions may be carried out at a lower speed, in which case the laser pulses may be interrupted partially by the shutter 25 under the control of the shutter driver 130 such that the radially adjacent pit-constituting dots 17a will be formed at the intervals equivalent to the track pitch.

The motor driver 150 is a known device which drives the motor 32 to rotate the optical disc 10. The motor driver 150 receives a synchronizing signal from the sync-generator 115, and the rotation speed of the optical disc 10 is regulated in accordance with the synchronizing signal. The rotation speed is regulated such that the circumferentially adjacent pit-constituting dots 17a will be formed contiguous to each other.

The focusing arithmetic unit 160 is a known device which receives a signal indicative of receipt of light from the second photosensor 29 and calculates the amount of control over the objective lens 27 for focusing the beam. The focusing arithmetic unit 160 is configured to calculate the amount of control, for example, using astigmatic focus error detection or any other methods. The result of calculation is outputted to the focusing coil driver 161.

The focusing coil driver 161 is a device which provides a driving signal to the focusing coil 41 in accordance with the amount of control calculated in the focusing arithmetic unit 160.

The memory 190 is a storage space capable of storing data for use in the controller 100 performing operations, such as modulation in the modulator circuit 110, data conversion and outputting operations in the data converter 111, where appropriate.

The operation of the optical disc drive 1 configured as described above will now be described in detail.

Data inputted to the controller 100 from a computer (PC) or the like is modulated by the modulator circuit 110 into first pit array data. The first pit array data is converted by the data converter 111 into second pit array data indicative of a linear array of pits as obtained as a result of scanning the pits 17 arranged in the track set 15 (see FIG. 5A), sequentially in radial directions of an optical disc 10 while rotating the optical disc 10.

The laser driver 120 drives the laser 22, and causes a pulsed laser beam to be emitted from the laser 22. The focusing coil 41, which is driven by the focusing coil driver 161, causes the pulsed laser beam to be focused on a position within the recording layer 13 of the optical disc 10.

The motor driver 150 rotates the motor 32, so as to rotate the optical disc 10.

When the optical disc 10 is rotated, the optical disc 10 moves relative to the optical pickup 20 in a direction indicated by an arrow A1 as shown in FIG. 5A. Meanwhile, the deflector driver 140 causes an area of the optical disc 10, which includes an area corresponding to one track set 15, to be scanned with the pulsed laser beam sequentially in the radial directions of the optical disc 10, so that the pulsed laser beam sweeps over the area of the optical disc 10 by moving in the radial directions of the optical disc 10 in zigzag as indicated by arrows A2 and A3 in FIG. 5A. Furthermore, the shutter driver 130 drives the shutter 25 in accordance with the second pit array data, so that the two-photon absorption reaction takes place selectively in the exposed portions of the recording layer 13, which results in modulation of absorptivity of light, or the like, and thus the pit-constituting dots 17a are formed in the recording layer 13.

In the present embodiment, when the track set 15 on the optical disc 10 is scanned with the pulsed laser beam inwardly in the radial directions (from the left to the right in FIG. 5A) as indicated by the solid arrows A2 in FIG. 5A, the pulsed laser beam is intermittently interrupted by the shutter 25 under the control of the shutter driver 150, and thus is interrupted and resumed according to the second pit array data. On the other hand, when the track set 15 on the optical disc 10 is scanned with the pulsed laser beam outwardly in the radial directions (from the right to the left in FIG. 5A) as indicated by the broken arrows A3 in FIG. 5A, the pulsed laser beam is interrupted by the shutter 25.

As described above, a plurality of the pit-constituting dots 17a are recorded in the recording layer 13 of the optical disc 10. When a circumferentially elongated pit 17 is to be formed, a pit-constituting dot 17a is formed contiguous to an adjacent pit-constituting dot 17a formed during the immediately preceding radial scanning operation. In other words, the radial scanning operations are performed with appropriate timing such that the circumferentially adjacent pit-constituting dots 17a partially overlap each other, with respect to the rotation speed of the optical disc 10. For example, three pit-constituting dots 17a as indicated by 17A, 17B and 17C in FIG. 5A become contiguous with each other, to form one elongated pit 17 having the length substantially equivalent to the total length of three pit-constituting dots 17a.

After the pit-constituting dots 17a (pits 17) in one track set 15 have been formed as described above, the actuator 35 is driven to move the optical pickup 20 to the next track set 15, and the pits 17 are formed in the next track set 15 in such a manner that the tracks 15a to be formed this time are aligned with and contiguous to the previously formed tracks 15a.

In this way, with the optical disc drive 1 according to the present embodiment, pit-constituting dots 17a (pits 17) can be formed in all the tracks 15a included in one track set 15 during the period of time when the optical disc 10 is caused to make one turn. Therefore, the high-speed data recording on an optical disc 10 can be achieved without the necessity to increase the rotation speed of the optical disc 10. For example, if the track set 15 is defined to contain one thousand tracks 15a, data can be recorded one hundred times as fast as is the case with the conventional optical disc drive, even when data is recorded at a rotation speed equivalent to one tenth of the conventional rotation speed. Furthermore, when an optical disc 10 on which information is recorded is manufactured by this optical disc drive 1, the manufacturing speed can be increased accordingly. In this respect, when relatively small volumes of DVD software products are to be manufactured, the optical disc drive 1 according to the present embodiment and the manufacturing process using this optical disc drive 1 can be suitably applicable.

When information is to be retrieved from the optical disc 10 on which information is recorded according to the present embodiment, the conventional optical disc drive may be used. To be more specific, the optical disc 10 is rotated and a laser beam is emitted to the rotating optical disc 10 so as to trace one track 15a as indicated by an arrow A4 in FIG. 5B. Then, the laser beam reflected from the reflecting layer 12 of the optical disc 10 is received by the second photosensor 29, and information is demodulated from an intensity signal of the received laser beam by a demodulator (not shown).

Although it is assumed in the present embodiment that a pattern of the pits 17 are read out by means of a pulsed laser beam, another optical pickup using a continuous-wave laser may alternatively be provided to retrieve data by means of a continuous-wave laser beam.

### Second Embodiment

A second embodiment of the present invention will now be described in detail. As the second embodiment provides a variation in which configuration of the first embodiment is partially modified, the same elements as in the first embodiment are designated by the same reference numerals, and a duplicate description will be omitted herein.

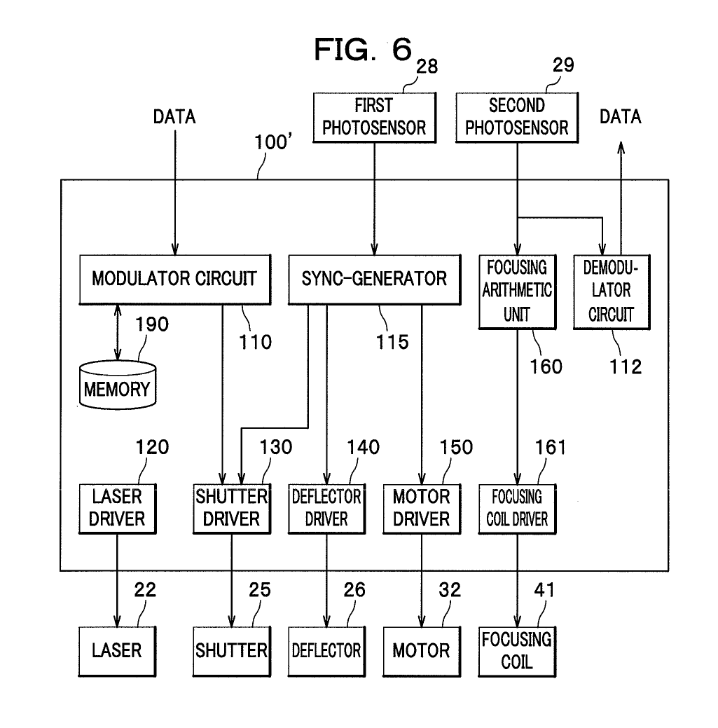

Referring to FIG. 6, which is a block diagram of a controller 100′ of an optical disc drive 1 according to the second embodiment, it is shown that no data converter 111 is provided and a demodulator circuit 112 is provided, in contrast to the controller 100 of the first embodiment.

Since the data converter 111 is not provided herein, pit array data (equivalent to the first pit array data in the first embodiment) generated in the modulator circuit 110 is provided as it is to the shutter driver 130.

The shutter driver 130 drives the shutter 25 in accordance with the pit array data received from the modulator circuit 110.

The demodulator circuit 112 is a known device which receives an intensity signal of the received laser beam from the photosensor 29 and demodulates an ON/OFF signal obtained from pits 17 into data using the same algorithm as used in the modulator circuit 110.

The speed of scanning the optical disc 10 with a pulsed laser beam sequentially in the radial directions is regulated by the deflector driver 140 such that the laser pulses sequentially directed to the optical disc 10 will be contiguous to overlap each other.

The rotation speed of the motor 32 driven by the motor driver 150 may preferably be regulated such that the circumferentially adjacent pit-constituting dots 17a will not overlap each other. However, the motor 32 may be rotated at slower speeds such that the circumferentially adjacent pit-constituting dots 17a will overlap each other. In this configuration, the laser pulses may be interrupted partially by the shutter 25 closed while the pulsed laser beam reciprocates several times under the control of the shutter driver 130 such that the circumferentially adjacent pit-constituting dots 17a will be formed at sufficient intervals.

The operation of the optical disc drive 1 configured as described above will now be described in detail.

Data inputted to the controller 100′ from a computer (PC) or the like is modulated by the modulator circuit 110 into pit array data indicative of a linear array of pits. The laser driver 120 drives the laser 22, and causes a pulsed laser beam to be emitted from the laser 22. The focusing coil 41, which is driven by the focusing coil driver 161, causes the pulsed laser beam to be focused on a position within the recording layer 13 of the optical disc 10.

The motor driver 150 rotates the motor 32, so as to rotate the optical disc 10.

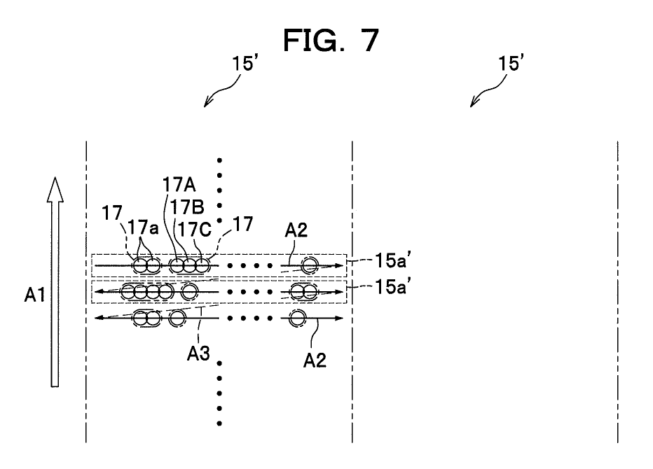

When the optical disc 10 is rotated, the optical disc 10 moves relative to the optical pickup 20 in a direction indicated by an arrow A1 as shown in FIG. 7. Meanwhile, the deflector driver 140 causes an area of the optical disc 10, which includes an area corresponding to one track 15′, to be scanned with the pulsed laser beam sequentially in the radial directions of the optical disc 10, so that the pulsed laser beam sweeps over the area of the optical disc 10 by moving in the radial directions of the optical disc 10 in zigzag as indicated by arrows A2 and A3 in FIG. 7. Furthermore, the shutter driver 130 drives the shutter 25 in accordance with the pit array data, so that the two-photon absorption reaction takes place selectively in the exposed portions of the recording layer 13, which results in modulation of absorptivity of light, or the like, and thus the pit-constituting dots 17a are formed in the recording layer 13.

In the present embodiment, when the track 15′ on the optical disc 10 is scanned with the pulsed laser beam inwardly in the radial directions (from the left to the right in FIG. 7) as indicated by the solid arrows A2 in FIG. 7, the pulsed laser beam is intermittently interrupted by the shutter 25 under the control of the shutter driver 150, and thus is interrupted and resumed according to the pit array data. On the other hand, when the track 15′ on the optical disc 10 is scanned with the pulsed laser beam outwardly in the radial directions (from the right to the left in FIG. 7) as indicated by the broken arrows A3 in FIG. 7, the pulsed laser beam is interrupted by the shutter 25.

The pit-constituting dots 17a as described above are recorded in such a manner that a second or further sequence of the pit-constituting dots 17a is recorded by radial scanning of the optical disc 10 with a laser beam in a position circumferentially adjacent to and spaced a predetermined distance apart from the preceding sequence of the pit-constituting dots 17a recorded by the last radial scanning of the optical disc 10 with a laser beam. In other words, the radial scanning operations are performed with appropriate timing such that the circumferentially adjacent pit-constituting dots 17a are spaced apart from each other, with respect to the rotation speed of the optical disc 10. For this purpose, the shutter 25 may be kept closed while the pulsed laser beam reciprocates several times in the radial directions.

On the other hand, in order to form an elongated pit 17, radially adjacent pit-constituting dots 17a are recorded contiguously to overlap each other. To be more specific, three pit-constituting dots 17a as indicated by 17A, 17B and 17C in FIG. 7 become contiguous with each other, to form one elongated pit 17 having the length substantially equivalent to the total length of three pit-constituting dots 17a.

After the pit-constituting dots 17a (pits 17) in one track 15′ have been formed as described above, the actuator 35 is driven to move the optical pickup 20 to the next track 15′, and the same recording control is repeated.

In this way, with the optical disc drive 1 according to the present embodiment, which is configured to form a plurality of radially extending recording segments 15a′ in one track 15′, pit-constituting dots 17a (pits 17) can be formed in all the recording segments 15a′ included in one track 15′ during the period of time when the optical disc 10 is caused to make one turn.

Therefore, the high-speed data recording on an optical disc 10 can be achieved without the necessity to increase the rotation speed of the optical disc 10. That is, the transfer rate at which the data is recorded can be increased.

When information is to be retrieved from the optical disc 10 on which information is recorded according to the present embodiment, a laser beam is emitted to scan therewith an area of the optical disc 10 which includes the same area as that for which the recording operation is performed (i.e., the area in which the pits are formed), sequentially in the radial directions of the optical disc 10, while the optical disc 10 is rotated. Then, the laser beam reflected from the reflecting layer 12 of the optical disc 10 is received by the second photosensor 29. Furthermore, information is demodulated from an intensity signal of the received laser beam by the demodulator 112.

In this way, all the pits 17 in the plurality of recording segments 15a′ included in one track 15′ can be scanned to retrieve the recorded data during the period of time when the optical disc 10 is caused to make one turn, and thus the data can be retrieved at high speeds without the necessity to increase the rotation speed of the optical disc 10. That is, the information can be retrieved more rapidly than can be in the conventional scheme.

Although it is assumed in the present embodiment that a pattern of the pits 17 are read out by means of a pulsed laser beam, another optical pickup using a continuous-wave laser may alternatively be provided to retrieve data by means of a continuous-wave laser beam.

According to the above-described embodiments of the present invention, as implemented in the methods and apparatuses for recording or retrieving information on an optical disc, the extremely high-speed data transfer can be achieved without increase in rotation speed of the optical disc, in comparison with the existing methods and apparatuses.

Although some exemplary embodiments of the present invention have been described above, the present invention is not limited to these embodiments, and may be carried out into practice in various other ways. Thus, it is contemplated that various modifications and changes may be made to the exemplary embodiments of the invention without departing from the scope of the embodiments of the present invention as defined in the appended claims.

For example, in describing the embodiments of the present invention, the tracks have been illustrated as being arranged spirally on the optical disc, but it is to be appreciated that the present invention is also applicable to the methods and apparatuses in which the plurality of tracks on which pits are formed to record information are arranged concentrically on the optical disc.

What is claimed is:

1. A method for recording information on an optical disc having a recording layer containing a two-photon absorption compound, the method comprising the steps of:
obtaining the information to be recorded, as first pit array data indicative of a first linear array of pits, wherein the pits in the first linear array correspond to those to be formed on a plurality of tracks arranged spirally or concentrically on the optical disc;
converting the first pit array data into second pit array data indicative of a second linear array of the pits, wherein the second linear array of the pits correspond to that to be obtained as a result of scanning, sequentially in radial directions of the optical disc, the pits arranged in the first linear array along the plurality of tracks on the optical disc; and
scanning an area of the optical disc, which includes an area corresponding to the plurality of tracks, with a pulsed laser sequentially in the radial directions of the optical disc while rotating the optical disc, wherein emission of a pulsed laser beam produced by the pulsed laser is interrupted and resumed according to the second pit array data.

2. The method according to claim 1, further comprising the steps of:
emitting a laser beam to the optical disc while rotating the optical disc so that the laser beam sequentially traces the tracks along which the pits are formed;
receiving the laser beam transmitted by or reflected from the optical disc; and
demodulating the information from an intensity signal of the received laser beam,
whereby information recorded on an optical disc is retrieved.

3. A method for recording information on an optical disc having a recording layer containing a two-photon absorption compound, the method comprising the steps of:
obtaining the information to be recorded, as pit array data indicative of a linear array of pits, wherein the pits in the linear array correspond to those to be formed on the optical disc; and
scanning the optical disc sequentially in radial directions of the optical disc with a pulsed laser while rotating the optical disc, wherein emission of a pulsed laser beam produced by the pulsed laser is interrupted and resumed according to the pit array data.

4. A method for retrieving information recorded on an optical disc having a recording layer containing a two-photon absorption compound, the method comprising the steps of:
receiving the optical disc on which information is recorded by the method according to claim 3;
emitting a laser beam and scanning an area of the optical disc in which the pits are formed, sequentially in the radial directions of the optical disc with the laser beam while rotating the optical disc;
receiving the laser beam transmitted by or reflected from the optical disc; and
demodulating the information from an intensity signal of the received laser beam.

5. A method for manufacturing an optical disc on which information is recorded, comprising the steps of:
providing an optical disc having a recording layer containing a two-photon absorption compound;
obtaining the information to be recorded, as first pit array data indicative of a first linear array of pits, wherein the pits in the first linear array correspond to those to be formed on a plurality of tracks arranged spirally or concentrically on the optical disc;
converting the first pit array data into second pit array data indicative of a second linear array of the pits, wherein the second linear array of the pits correspond to that to be obtained as a result of scanning, sequentially in radial directions of the optical disc, the pits arranged in the first linear array along the plurality of tracks on the optical disc; and
scanning an area of the optical disc, which includes an area corresponding to the plurality of tracks, with a pulsed laser sequentially in the radial directions of the optical disc while rotating the optical disc, wherein emission of a pulsed laser beam produced by the pulsed laser is interrupted and resumed according to the second pit array data.

6. An apparatus for recording information on an optical disc having a recording layer containing a two-photon absorption compound, the apparatus comprising:
a pulsed laser configured to produce a pulsed laser beam;
a shutter configured to interrupt and resume emission of the pulsed laser beam produced by the pulsed laser;
a deflector configured to deflect the pulsed laser beam produced by the pulsed laser, in radial directions of the optical disc;
a motor configured to rotate the optical disc; and
a controller configured to control the pulsed laser, the shutter, the deflector and the motor, the controller comprising:
a modulator configured to modulate information to be recorded into first pit array data indicative of a first linear array of pits, wherein the pits in the first linear array correspond to those to be formed on a plurality of tracks arranged spirally or concentrically on the optical disc;
a data converter configured to convert the first pit array data into second pit array data indicative of a second linear array of the pits, wherein the second linear array of the pits correspond to that to be obtained as a result of scanning, sequentially in radial directions of the optical disc, the pits arranged in the first linear array along the plurality of tracks on the optical disc;
a pulsed laser driver configured to cause the pulsed laser to produce the pulsed laser beam;
a motor driver configured to cause the motor to rotate the optical disc;
a deflector driver configured to regulate the deflector so as to scan an area of the optical disc, which includes an area corresponding to the plurality of tracks, with the pulsed laser sequentially in the radial directions of the optical disc; and
a shutter driver configured to cause the shutter to selectively interrupt or resume emission of the pulsed laser beam according to the second pit array data.

7. An apparatus for recording information on an optical disc having a recording layer containing a two-photon absorption compound, the apparatus comprising:
a pulsed laser configured to produce a pulsed laser beam;
a shutter configured to interrupt and resume emission of the pulsed laser beam produced by the pulsed laser;
a deflector configured to deflect the pulsed laser beam produced by the pulsed laser, in radial directions of the optical disc;
a motor configured to rotate the optical disc; and
a controller configured to control the pulsed laser, the shutter, the deflector and the motor, the motor comprising:
a modulator configured to modulate information to be recorded into first pit array data indicative of a first linear array of pits, wherein the pits in the first linear array correspond to those to be formed on a plurality of tracks arranged spirally or concentrically on the optical disc;
a pulsed laser driver configured to cause the pulsed laser to produce the pulsed laser beam;
a motor driver configured to cause the motor to rotate the optical disc;
a deflector driver configured to regulate the deflector so as to scan an area of the optical disc, which includes an area corresponding to the plurality of tracks, with the pulsed laser sequentially in radial directions of the optical disc; and
a shutter driver configured to cause the shutter to selectively interrupt or resume emission of the pulsed laser beam according to the second pit array data.
